(19) United States
(12) Patent Application Publication
(10) Pub. No.: US 2024/0310513 A1
(43) Pub. Date: Sep. 19, 2024

(54) SYSTEM AND METHOD FOR USING A SYNTHETIC-APERTURE RADAR

(71) Applicant: HISEP TECHNOLOGY LTD., Yavne (IL)

(72) Inventors: YARIV ERAD, KIDRON (IL); GAD VERED, BE'ER YA'AKOV (IL); URI VERED, RISHON LEZION (IL); MENACHEM ERAD, ASHDOD (IL)

(21) Appl. No.: 17/236,128

(22) Filed: Apr. 21, 2021

Related U.S. Application Data
(60) Provisional application No. 63/012,947, filed on Apr. 21, 2020.

(51) Int. Cl. G01S 13/90; G01S 7/40; G01S 7/41; G01S 13/58

(52) U.S. Cl. CPC G01S 13/9004; G01S 7/403; G01S 7/415; G01S 13/581

(57) ABSTRACT

A system including a device having a body, at least one Synthetic-aperture radar (SAR) coupled to the body, at least one rail coupled to the body, and an actuator for moving the SAR along the at least one rail.

### FIELD

The present disclosure generally relates to using a Synthetic-aperture radar mounted on a device.

### BACKGROUND

Synthetic-aperture radar (SAR) is a form of radar used to create two-dimensional images or three-dimensional reconstructions of objects, such as landscapes. SAR uses the motion of the radar's antenna over a target region to provide finer spatial resolution than conventional beam-scanning radars. SAR is typically mounted on a moving platform, such as aircrafts, spacecrafts or cars, and has its origins in an advanced form of side looking airborne radar (SLAR). The distance the SAR device travels over a target in the time taken for the radar pulses to return to the antenna creates a large synthetic antenna aperture (the size of the antenna). Typically, the larger the aperture, the higher the image resolution will be, regardless of whether the aperture is physical (a large antenna) or synthetic (a moving antenna). This allows SAR to create high-resolution images with comparatively small physical antennas. Additionally, SAR has the property of having larger apertures for more distant objects, allowing consistent spatial resolution over a range of viewing distances.

To create a SAR image, successive pulses of radio waves are transmitted to “illuminate” a target scene, and the echo of each pulse is received and recorded. The pulses are transmitted and the echoes received using a single beam-forming antenna, with wavelengths ranging from a meter down to several millimeters. As the SAR device is placed on a moving platform (such as on board the aircraft or spacecraft that moves), the antenna's location relative to the target changes with time. Signal processing of the successive recorded radar echoes allow the combining the recordings from these multiple antenna positions. This process forms the synthetic antenna aperture and allows the creation of higher-resolution images than would otherwise be possible with a given physical antenna.

The resolution of radar imaging is directly proportional to the antenna's diameter, named aperture. Since there is a limitation as per the antenna size, regular radars are not fit for imaging. One can fly the radar in an airplane, thus moving its position over large distance, e.g., 1 Km. The received echoes are recorded and integrated to one outcome. The result is equivalent to a radar whose aperture is 1 Km in this example, thus the name Synthetic Aperture Radar—SAR.

The high image resolution encourages the usage of airborne and satellites for remote sensing, providing high resolution images rather than locating an object as a regular radar usage. In a typical SAR application, a single radar antenna is attached to an aircraft, spacecraft or vehicle, such that a substantial component of the antenna's radiated beam has a wave propagation direction perpendicular to the flight-path direction.

The process can be thought of as combining the series of spatially distributed observations as if all had been made simultaneously with an antenna as long as the beam is focused on that particular point. The “synthetic aperture” simulated at maximum system range by this process not only is longer than the real antenna, but, in practical applications, it is much longer than the radar aircraft, and tremendously longer than the radar spacecraft.

### SUMMARY

The subject matter discloses a system having a body and a SAR system moving relative to the body, for example using an arm or a rail. The subject matter thus enables using a SAR system installed on non-moving and moving elements such as walls, everyday objects, clothes, and others. Prior art systems, in which the SAR system does not move relative to a moving object such as a car or motorcycle or bicycle—cannot function when the object is stationary/idle or be affected looking forward.

In one aspect the subject matter discloses a system, comprising a device having a body; at least one Synthetic-aperture radar (SAR) coupled to the body; at least one rail coupled to the body; an actuator for moving the SAR along the at least one rail. In some cases, the system further comprising at least one antenna allocated to each SAR of the at least one SAR. In some cases, the device comprises multiple antennas and multiple SARs and a switching circuitry for switching the antennas allocated to a selected SAR of the multiple SARs. In some cases, the system further comprising a tilting mechanism for tilting the antenna alignment in the SAR such that a sector scanned by the radar changes relative to the body. In some cases, the system further comprising multiple rails spanning the body, at least two rails of the multiple rails intersect with each other, wherein the actuator moves the SAR from a first rail of the multiple rails to a second rail of the multiple rails. In some cases, the at least one rail is foldable.

In some cases, the system further comprising an alignment actuator for changing an alignment of the at least one rail thereby changes the alignment of the device. In some cases, the system further comprising a rail actuator for moving the at least one rail relative to the body. In some cases, the system further comprising at least one image sensor. In some cases, the system further comprising an image sensor actuator for aligning the image sensor to the direction of the SAR device. In some cases, the system further comprising direction-finding means. In some cases, the system further comprising a memory device for storing information defining objects, wherein the SAR is configured to detect the objects, wherein the SAR moves in response to movement of the objects.

In another aspect the subject matter discloses a method of operating a system having a Synthetic-aperture radar (SAR), the method comprising receiving a command to use the SAR, the command comprising an azimuth; moving the SAR along a rail in a body of the system, without changing an azimuth of a body of the system; sending a confirmation message indicating that the SAR is in position based on the command.

In some cases, the method further comprising changing an alignment of the rail based on the azimuth. In some cases, the method further comprising tilting the antenna alignment in the SAR such that a sector scanned by the radar changes relative to the body. In some cases, the method further comprising folding the rail inside the system.

In some cases, the system comprising multiple rails spanning in the body, at least two rails of the multiple rails intersect with each other and the method further comprising moving the SAR from a first rail of the multiple rails to a second rail of the multiple rails. In some cases, the method further comprising identifying movement of the system's body and moving the SAR on a rail having a direction perpendicular to the body's movement.

In some cases, the method further comprising detecting an alignment of the system's body and changing an alignment of the rail according to the detected alignment. In some cases, the method further comprising identifying a relative direction of a source of a signal using a direction-finding (DF) unit and adjusting an alignment of the SAR to be directed at the identified relative direction of the source. In some cases, the method further comprising identifying an object using a camera and adjusting an alignment of the SAR to be directed at the identified relative direction of the source. In some cases, the method further comprising receiving a command from a user operating the system and adjusting the alignment of the SAR to be directed according to the command. In some cases, the method further comprising receiving a signal by the antennas and identifying a physical object based on the signal.

### BRIEF DESCRIPTION OF THE DRAWINGS

The invention may be more clearly understood upon reading of the following detailed description of non-limiting exemplary embodiments thereof, with reference to the following drawings, in which:

FIG. 1 schematically shows a system having a SAR radar mounted on a movable wing, according to exemplary embodiments of the invention;

FIG. 2 schematically shows a system having a SAR radar mounted on a movable wing, according to exemplary embodiments of the invention;

FIGS. 3A-3D schematically show a system having multiple linear rails used to carry and move a SAR radar, according to exemplary embodiments of the invention;

FIG. 4 schematically shows a system having an elliptical rail used to carry and move a SAR radar, according to exemplary embodiments of the invention;

FIG. 5 schematically shows a vehicle having a rail used to carry and move a SAR radar, according to exemplary embodiments of the invention;

FIG. 6 schematically shows a motorcycle having a rail used to carry and move a SAR radar, according to exemplary embodiments of the invention;

FIG. 7 schematically shows an aerial vehicle having a rail used to carry and move a SAR radar, according to exemplary embodiments of the invention;

FIG. 8 schematically shows a bicycle having a rail used to carry and move a SAR radar, according to exemplary embodiments of the invention;

FIG. 9 schematically shows a display device a rail used to carry and move a SAR radar, according to exemplary embodiments of the invention;

FIG. 10 schematically shows an environment in which a movable SAR radar detects a person pointing at an object, according to exemplary embodiments of the invention;

FIGS. 11A-11E schematically show eyeglasses having a rail used to carry and move a SAR radar, according to exemplary embodiments of the invention;

FIG. 12 shows a method for operating a SAR radar, according to exemplary embodiments of the invention;

FIG. 13 shows a physical device comprising two tags configured to be identified by a radar, according to exemplary embodiments of the invention;

FIG. 14 shows a radar receiving a reflected pulse from a physical device comprising tags, according to exemplary embodiments of the invention;

FIGS. 15A-15B show a method for determining an orientation of a physical device using tags placed on the device and a radar, according to exemplary embodiments of the invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

For the purposes of this paper, and in order to enable clear understanding of the invention described herewith, the definitions and terms used in this paper shall have the meaning set forth beside them as well as the broadest meaning resulting from their context. However, it should be clearly understood, that the use of such meanings shall in no way serve to limit the scope of possible interpretation of the ideas, and the ideas and concepts provided herewith shall apply even if other terms and definitions are used.

The examples provided in this paper relate to the use of the invention for various applications. However, it is clearly stated that the use of the invention can apply to other types of applications and devices, and for any device or application. In these cases, the features of the inventions described hereunder shall apply as well.

The term “Direction-Finding (DF)” refers to any applicable technology, method or technique—including hardware, software, Algorithms, antennas, materials—including UWB-based DF techniques-that is used to find relative direction and/or distance and/or height between at least two devices and/or objects. The DF can be based on radio waves (RF) and/or light waves and/or sound waves.

The term “motion sensor” may refer to an accelerometer sensor or component that measures proper acceleration—i.e., the acceleration experienced relative to freefall. Single- and multi-axis models are available to detect magnitude and direction of the acceleration as a vector quantity, and can be used to sense position, vibration and shock. The motion sensor may comprise a Gyroscope sensor or component for measuring or maintaining orientation, based on the principles of conservation of angular momentum. The motion sensor may be a tilt sensor used to measure the tilting in two axes of a reference plane in two axes, in portable electronic devices.

The term “wireless communication” shall refer to the transfer of information and/or data and/or packets (formatted blocks of data) and/or communication acknowledgment/no-acknowledgment and/or voice over long or short distances without the use of electrical conductors or “wires” but via Radio waves and/or light waves and/or sound waves, at any given frequency—such as, but not limited to—5 Khz-600 Ghz. Said wireless communication means may use any protocol or standard in any given frequency that can be used to conduct Radio and/or light and/or sound Wireless Communication, such as, but not limited to, wireless Information Technology, cellular communication (such as, but not limited to, GSM, GPRS, CDMA), Wireless Networks, WLAN computer communications, wireless networking standards (such as IEEE 802.11), wireless personal area networks (WPAN) and wireless mesh networks, and “Internet-of-Things”.

The term “Absorbing material” refers to the weakening and/or reduction in strength and/or attenuation of a wireless signal/wave—all of it or part of it—that occurs as it passes through objects and/or lossy medium and/or materials with dielectric loss properties (such as, but not limited to, the human body and/or materials with absorbing properties. Said Absorbing material may have predefined properties corresponding with the wave type and/or frequency it is aimed to absorb. “Absorbing material” may also refer to intentional delay of an electromagnetic wave and/or light wave and/or sound wave time-of-flight.

The subject matter discloses a system comprising at least one SAR radar, each radar of the at least one radar comprises at least one antenna. The SAR radar as defined herein also includes an ISAR radar (Inverse SAR radar). In some cases, the subject matter discloses a system comprising at least one SAR radar and/or one ISAR radar. The SAR radar and ISAR radar—together or separately—may be referred herein as “the radar”). The system also comprises an actuator for actuating the radar, or at least one antenna, relative to the system's body. The actuator may be a motor, for example using hydraulic energy, electronic energy, or any other type of energy desired by a person skilled in the art. The actuator may be coupled to the at least one antenna, or to a device carrying the antenna. The actuator may be coupled to a transceiver for receiving a command from another device or electrical component, such as a processor, and moves the antenna according to the command. The actuator may move the antenna along a rail located in the body of the system, or carried by the system. The actuator may operate an arm carrying the radar's antenna. The system may comprise at least one said electronic device and means to enable the electronic the device to be moved in a free-form manner (i.e., not on tracks or rails). For example, said moving means may include the use of a magnetic field applied to a surface that can change its properties to enable moving the electronic device in any given direction and in any given trajectory.

The system may comprise more than one antenna per radar. The antennas may be allocated to different frequencies (including, but not limited to, UWB frequencies). The antennas may be allocated to enable operation in more than one frequency per antenna. The system may shift between the antennas used for the radar's operation. The system may use at least two antennas in different frequencies for the radar's operation at the same time, and may ensure that there are no interferences between the antennas. The antennas may be in a phase-array configuration. The antennas may part of an antenna array. The system may rotate at least one antenna and/or at least one antenna array and/or sensors in 360 degrees. The antennas may be attached to and/or placed on and/or include absorbing material—such as, but not limited to, RF absorbing materials, sound absorbing materials, light absorbing materials.

The system may comprise mechanical elements to tilt and/or shift the antenna alignment in it, in such manner that the scanned sector will be change due to the changed alignment. The system may change the alignment of the rails to fit with the alignment of the system's main body part. The system may move the electronic device in 3D direction—i.e., horizontally, vertically, and in alignments based on the rails position (for example, in a possible embodiment the rail is placed vertically so the electronic device can be moved up/down. Such system can be placed on a vertical wall or any vertical element). The rail system may have means to wirelessly communicate with the electronic device and to exchange data and telemetry with it, including alignment information, performance information, status information and the like.

The subject matter also discloses a system comprising at least one said electronic device and a rail element enabling moving the electronic device on the rail. The rail system may comprise means to move the electronic device in opposing directions.

The rail system may comprise means to move the electronic device at different speeds and/or to stop its movement at any given location. The rail system may comprise means to add additional rails and intersection elements so the electronic device can move between one rail to another. The rail system may comprise means to expend the rails from a foldable condition to an extended position and back to a folding position. The rail system may comprise means to charge the electronic device. The rail system may comprise means to enable several electronic devices to move on the rails at the same time, and means to manage said movement to avoid any collisions. The rail system may be made of a flexible material, enabling the rails to flex to fix the contour of the object they are placed on. The rail system may be integrated into other objects as part of these object's manufacturing process. The rail system may include means to attach the rails to objects. The rail system may include a power supply source and/or connection, data lines, other type of cable (including coaxial cables), processors, interface means—all in such manner that will enable moving the electronic device.

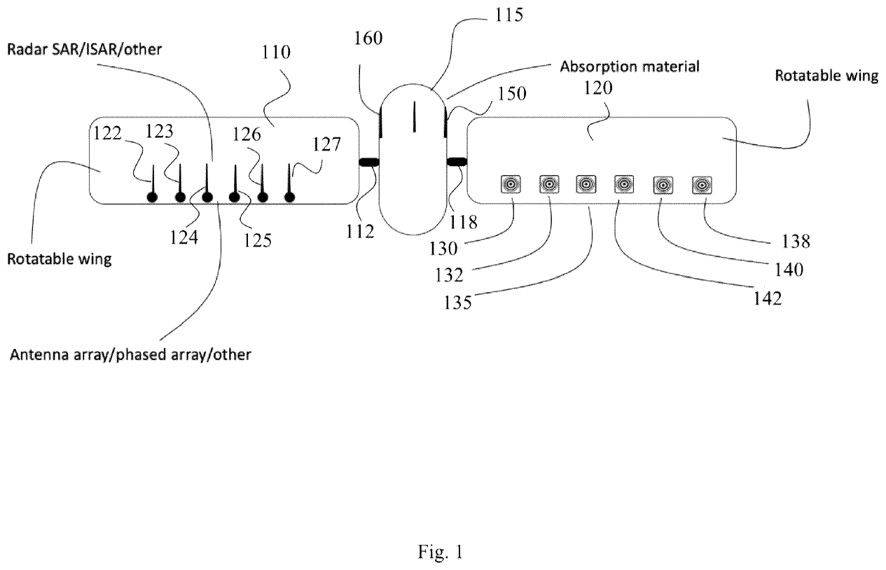

FIG. 1 schematically shows a system having a SAR radar mounted on a movable wing, according to exemplary embodiments of the invention. The system comprises a main body part 115 and two wings 110, 120, coupled to the main body part 115 using connectors 112, 118, respectively. The connectors 112, 118 enable rotation of the wings 110, 120. The rotation may be defined such that the wings 110, 120 may be aligned differently relative to the main body part 115. For example, wing 110 may rotate 10 degrees relative to the main body part 115, and wing 120 may rotate 30 degrees relative to the main body part 115. Rotation of the wings 110, 120 enables to direct the radar's antennas to a specific direction.

The main body part 115 may comprise main electrical circuitry, comprising antennas 150, 160. The main electrical circuitry may also comprise a wireless transceiver for exchanging wireless signals with other devices. At least one of the wings 110, 120 comprises antennas for collecting signals used to generate images by the radar. For example, wing 110 comprises antennas 122, 123, 124, 125, 126 and 127. The second wing 120 may also comprise antennas for capturing signals used to create images. At least one of the wings 110, 120 may comprise sensors. The sensors may include at least one of the following: lidar sensor 130, laser sensor 132, proximity sensor 135, Infra-Red sensor 138, image sensor 140, and temperature sensor 142. Other sensors may also be contained in the system.

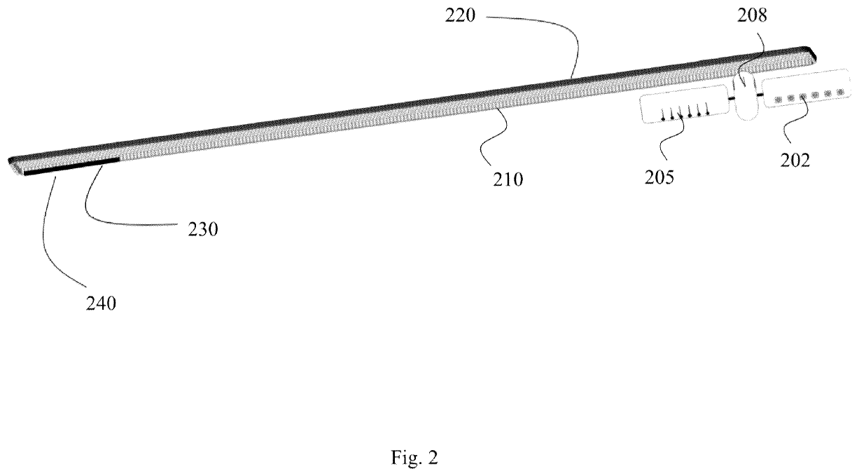

FIG. 2 schematically shows a rail system used to move a SAR radar, according to exemplary embodiments of the invention. The rail 210 may be placed on an external surface of the system. In some other cases, the rail 210 may be placed inside a housing. The rail 210 may comprise a physical connector 220 for connecting the rail 210 to the body of the system. The connector 220 may include a bar coupled to the system's body using screws, pins, or any other connecting mechanism desired by a person skilled in the art. The rail may comprise a power line 240 for providing power to the rail's electrical components, such as transceiver 230 for receiving commands from the system's processor, and a motor for changing an alignment of the rail 210 relative to the system's main body, if requested. The motor may also move the radar 208 along the rail 210. The radar may comprise wings 202, 205, similar to wings 110, 120 of FIG. 1.

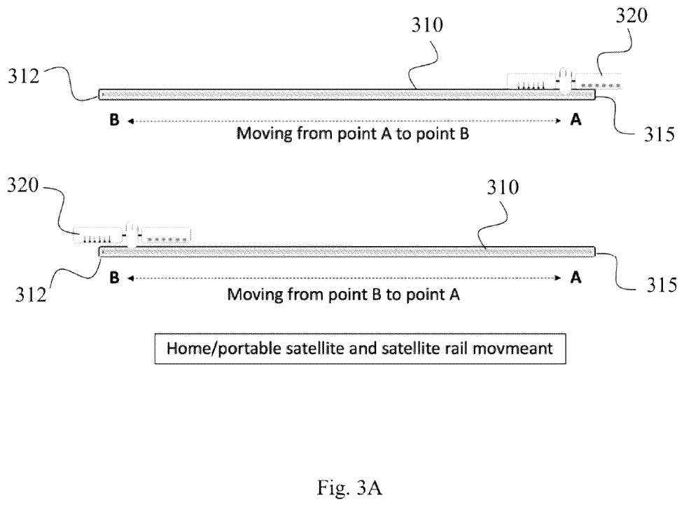

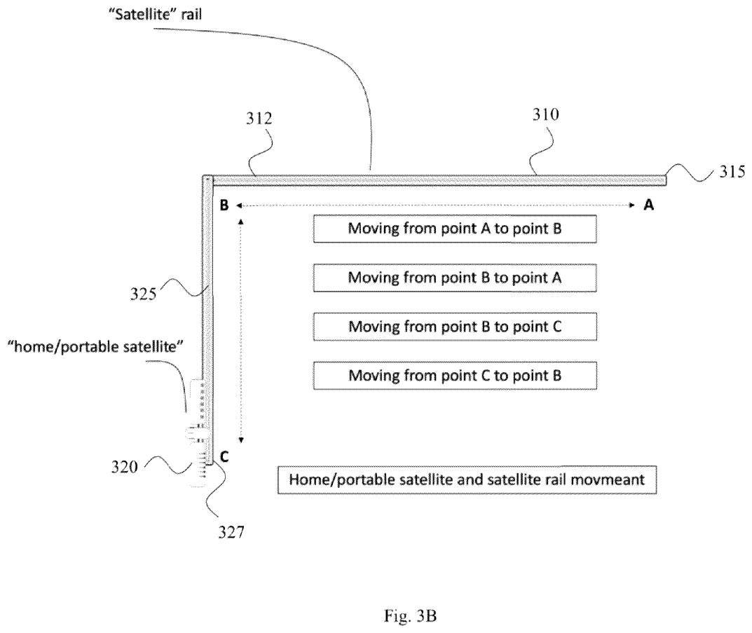

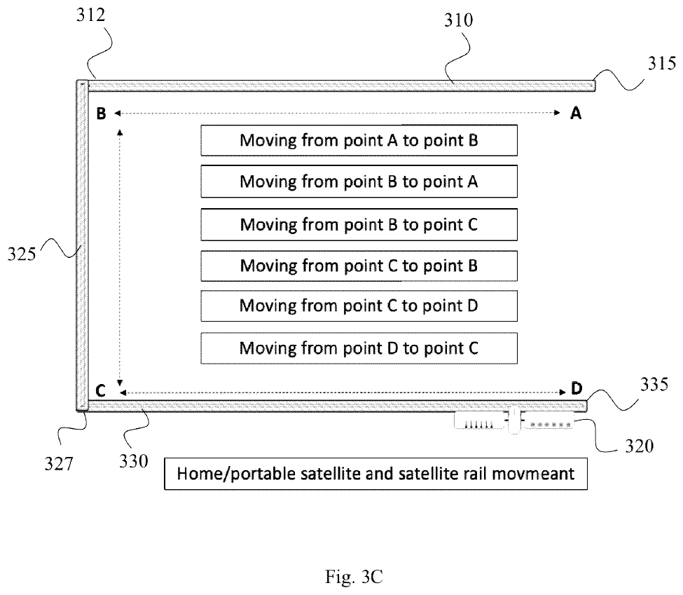

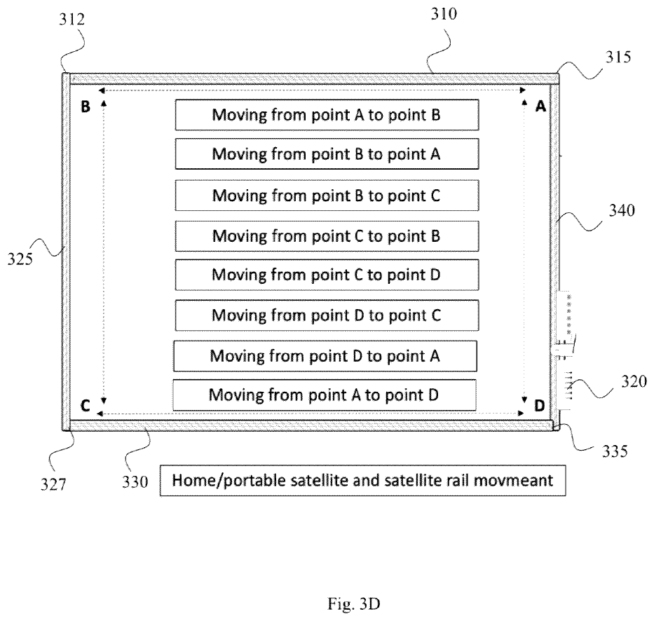

FIGS. 3A-3D schematically show a system having multiple linear rails used to carry and move a SAR radar, according to exemplary embodiments of the invention. FIG. 3A shows a single rail 310 used to carry radar 320. The single rail spans between ends 312 and 315. The radar 320 may be positioned in any point along the rail 310 between ends 312 and 315. The rail's length may be in the range of 0.5-500 meters. The rail may be placed on a stationary location, for example a building's roof, or a movable object, such as a train.

FIG. 3B shows two rails 310, 325, intersecting with each other in point 312. Rail 310 spans between two ends 310, 315, and rail 325 spans between two ends 312 and 327. The radar 320 may move between the rails 310, 325 via intersection point 312.

FIG. 3C shows three rails 310, 325, 330. Rails 310 and 325 intersect with each other in point 312, while rails 330 and 325 intersect with each other in point 327. Rail 310 spans between two ends 310, 315, rail 325 spans between two ends 312 and 327, and rail 330 spans between two ends 335 and 327. The radar 320 may move between the rails 310, 325 and 330 via intersection points 312 and 327.

FIG. 3D shows four rails 310, 325, 330, 340. Rails 310 and 325 intersect with each other in point 312, while rails 330 and 325 intersect with each other in point 327, rails 330 and 340 intersect with each other in point 335 and rails 340 and 310 intersect with each other in point 315. Rail 310 spans between two ends 310, 315, rail 325 spans between two ends 312 and 327, rail 330 spans between two ends 335 and 327 and rail 340 spans between two ends 335 and 315. The radar 320 may move between the rails 310, 325, 330 and 340 via intersection points 312, 315, 327 and 335.

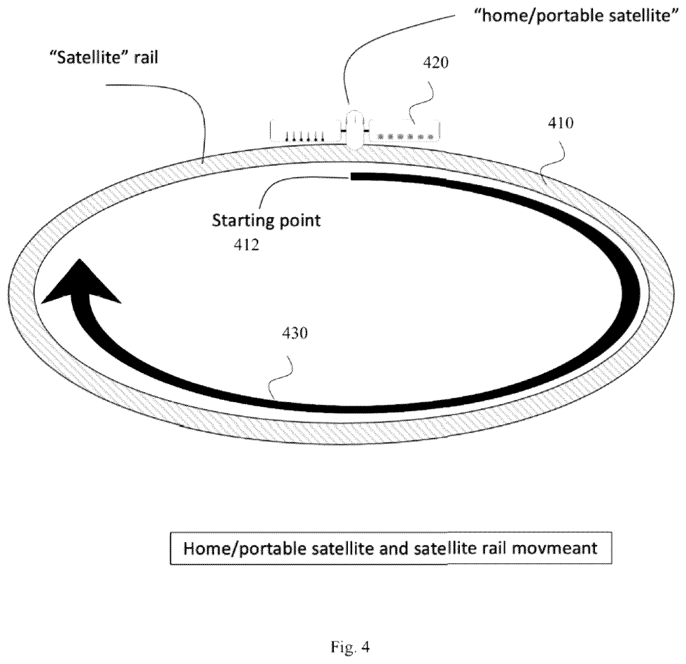

FIG. 4 schematically shows a system having an elliptical rail used to carry and move a SAR radar, according to exemplary embodiments of the invention. The radar 420 moves along the elliptical rail 410 clockwise as shown by arrow 430 or counterclockwise. The radar 420 may move in response to a command received from another device, or based on the readings or measurements of sensors and/or antennas located in the radar 420. The radar 420 may be placed initially in starting point 412. The starting point 412 may be equipped with a power source for providing electrical power to the radar's components.

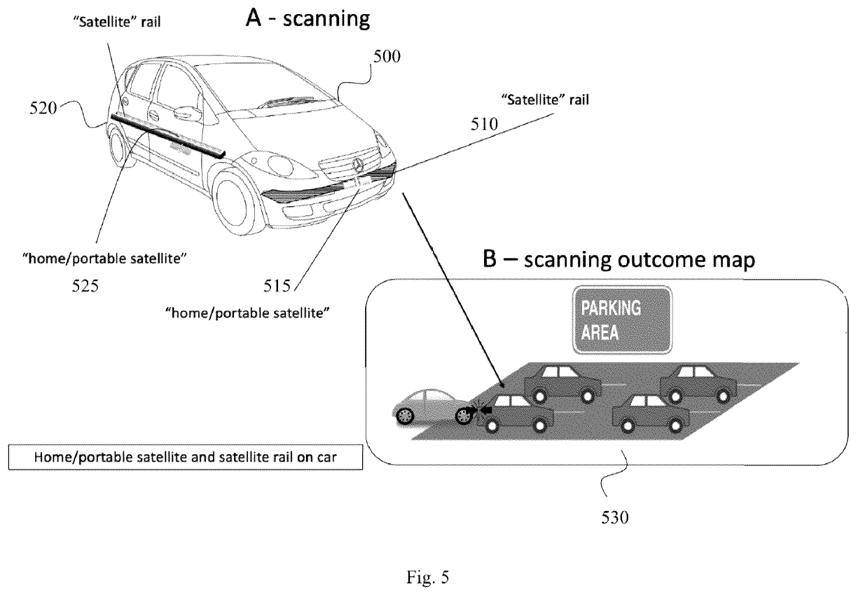

FIG. 5 schematically shows a vehicle having a rail used to carry and move a SAR radar, according to exemplary embodiments of the invention. The vehicle 500 may be a car, a truck, a bus, and any other motorized vehicle having at least two seats. The vehicle 500 comprises a front rail 510 enabling movement of a front radar 515. The vehicle may also comprise a side rail 520 enabling movement of a side radar 525. FIG. 5 also shows an exemplary map 530 created by the front radar 515.

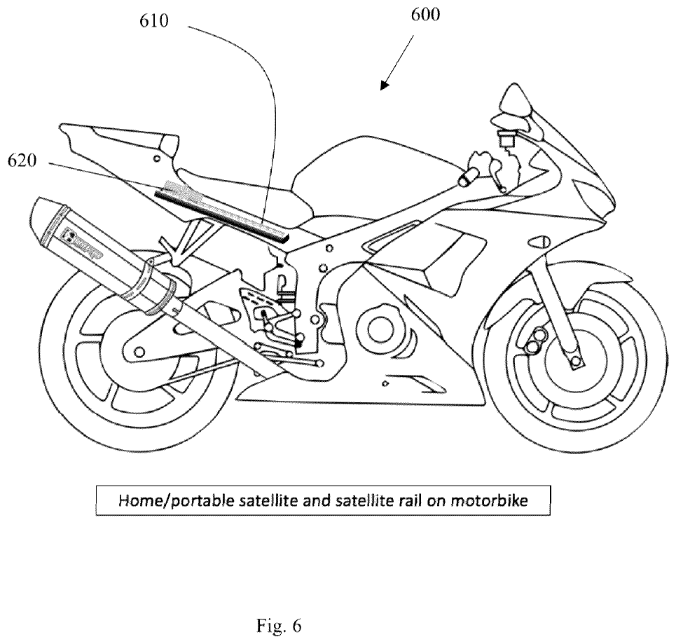

FIG. 6 schematically shows a motorcycle having a rail used to carry and move a SAR radar, according to exemplary embodiments of the invention. The motorcycle 600 has a seat and a chassis. Rail 610 is coupled to the motorcycle's chassis. The rail 610 enables movement of the radar 620 in the longitudinal axis of the motorcycle, defined from the front end to the rear end of the motorcycle 600. The radar 620 may be directed to the side, the front or the rear view of the motorcycle 600.

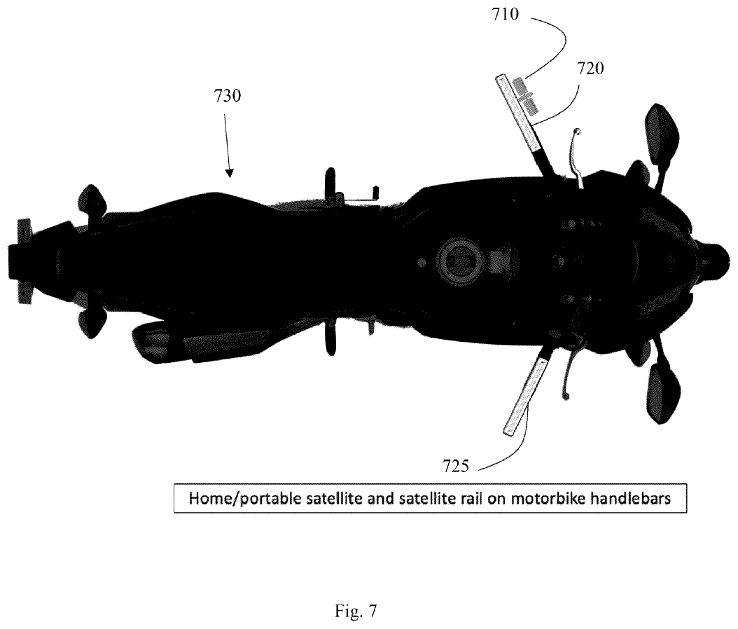

FIG. 7 schematically shows an aerial vehicle having a rail used to carry and move a SAR radar, according to exemplary embodiments of the invention. The aerial vehicle has a body 730 and two rails 720, 730 extending form the body 730. Radar 710 may move from one rail 720 to another rail 730 via an intersection point.

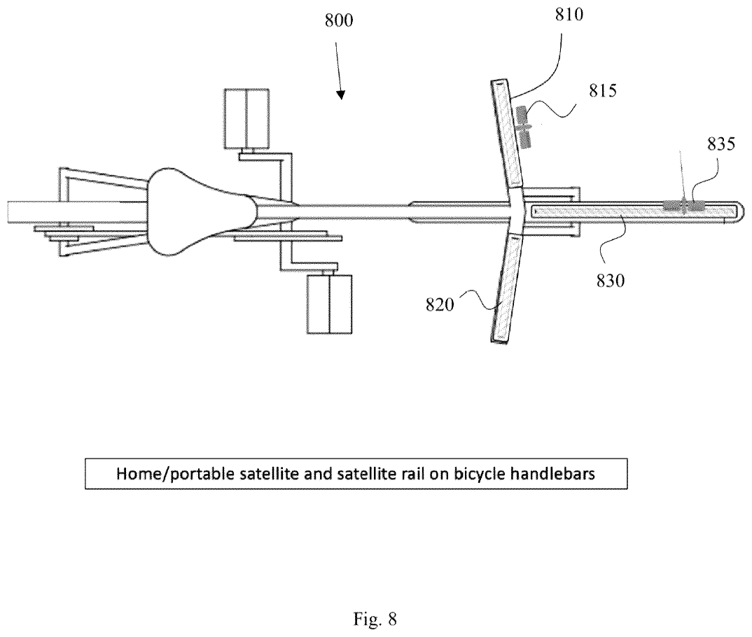

FIG. 8 schematically shows a bicycle having a rail used to carry and move a SAR radar, according to exemplary embodiments of the invention. The bicycle 800 has two wheels, handlebars and a seat. In some exemplary embodiments, the bicycle 800 has a pair of rails 810, 820 coupled to the handlebars. Radar 815 may move along the rails 810 and 820. The bicycle 800 may also comprise a second rail 830 located above the front wheel of the bicycle 800, carrying a second radar 835. The radars 815, 835 may be directed upwards, downwards, to the front or rear side of the bicycle 800, or sidewards.

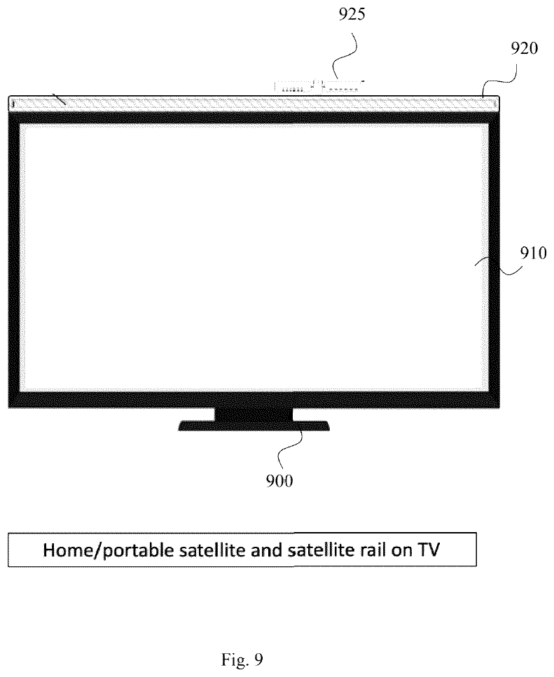

FIG. 9 schematically shows a display device a rail used to carry and move a SAR radar, according to exemplary embodiments of the invention. The display device may have a display base 900 for mounting the display device in a stable manner on a surface, such as a table or shelf. The display device also comprises a monitor 910 for displaying content, and a rail 920 located above the monitor 910. The rail 920 enables movement of the radar 925 along the length of the monitor 910.

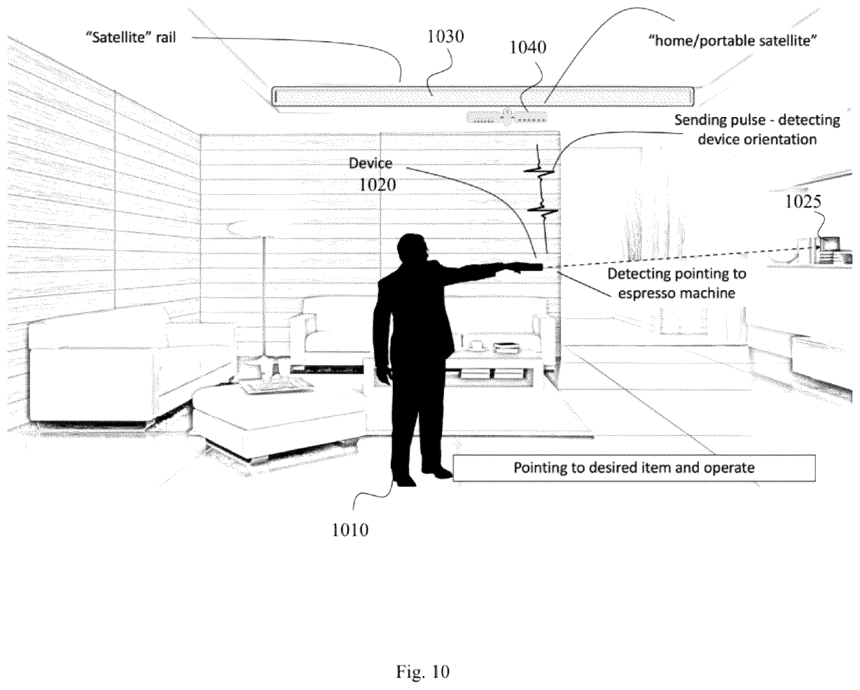

FIG. 10 schematically shows an environment in which a movable SAR radar detects a person pointing at an object, according to exemplary embodiments of the invention. Person 1010 carries a pointer 1020 used to point at some direction. The pointer 1020 may be a laser pointer, or any pointer that emits light. The pointer's direction may be computed by sensors located in the pointer 1020. The pointer's direction may be sent to the radar 1040, or to a device communicating with the radar. The radar 1040 may then move along the rail 1030 according to the direction at which the pointer 1020 is headed. For example, in case the pointer 1020 points at device 1025, the radar 1040 will move to the right side of the rail 1030, to create an image containing the device 1025.

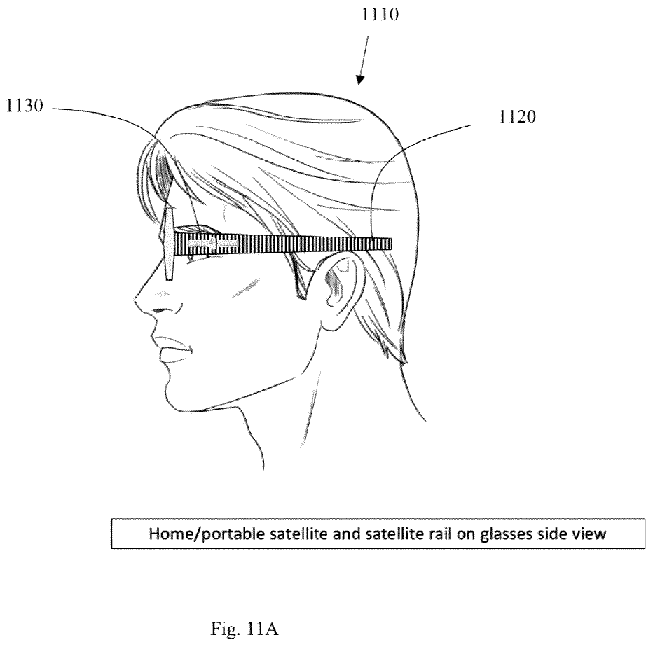

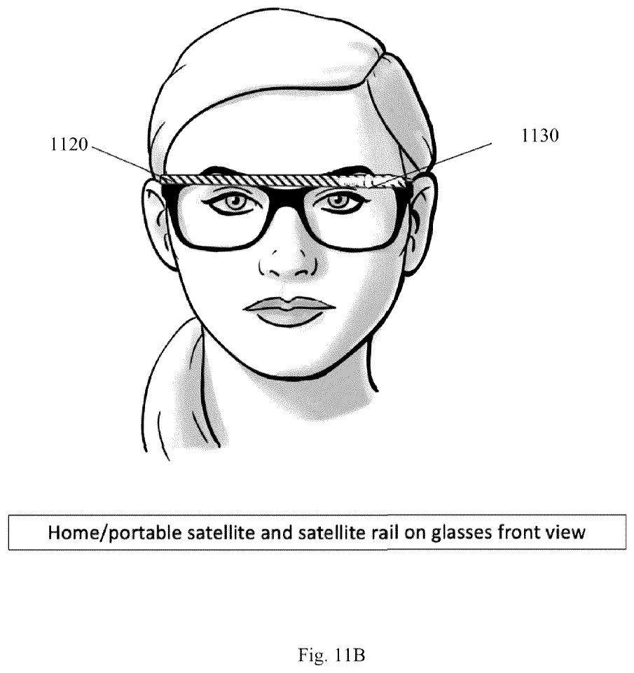

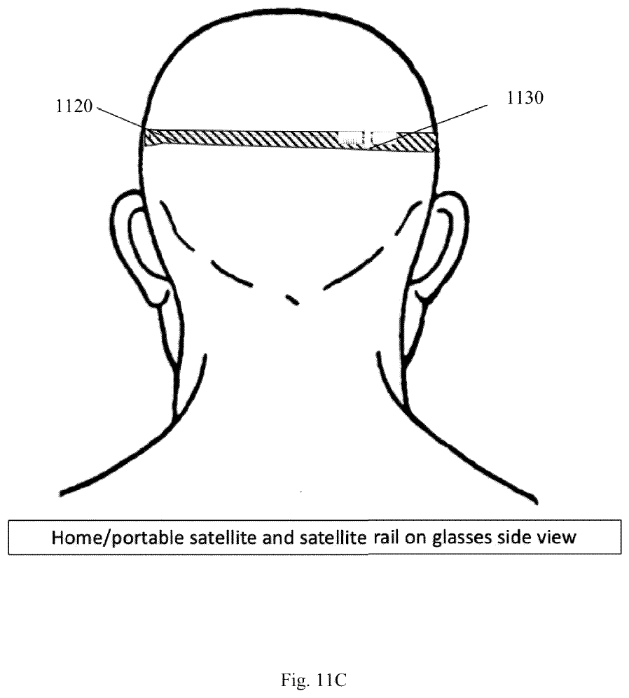

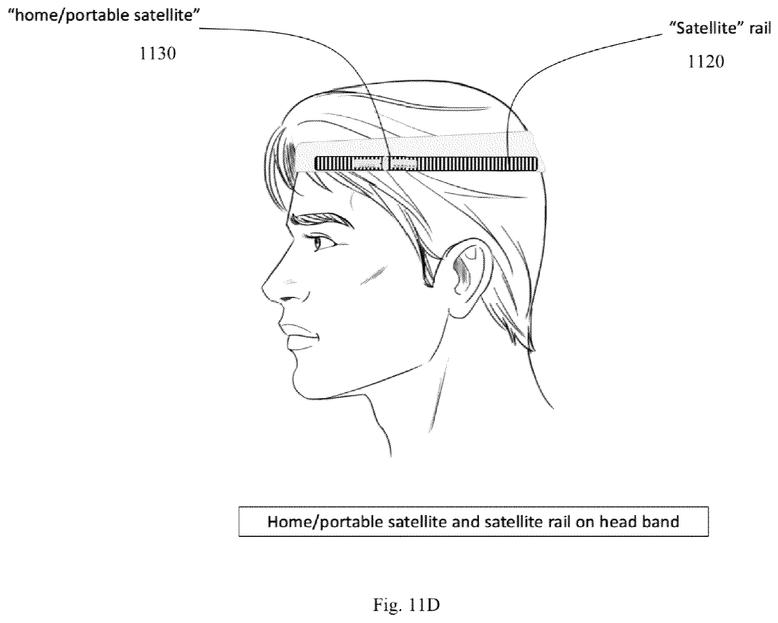

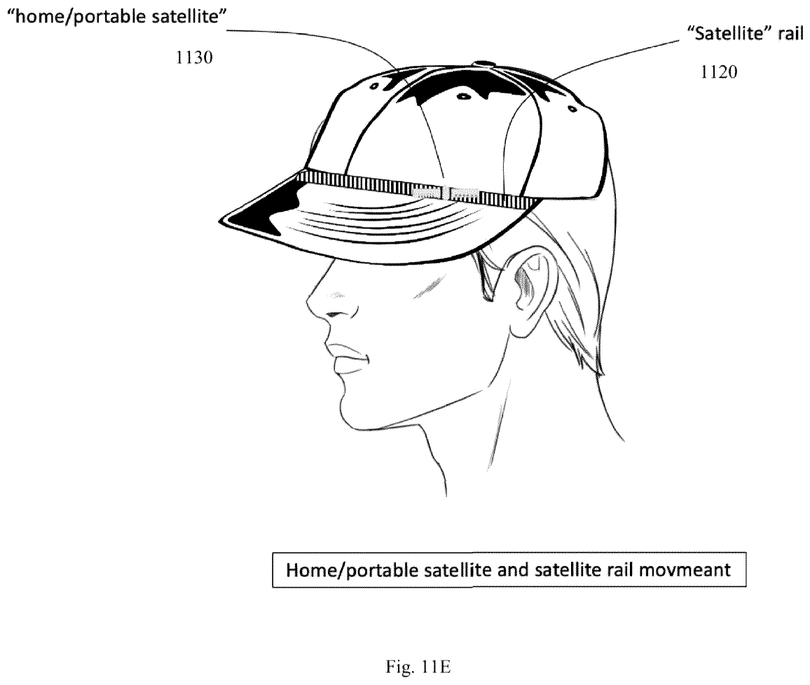

FIGS. 11A-11E schematically show eyeglasses having a rail used to carry and move a SAR radar, according to exemplary embodiments of the invention. Person 1110 wears eyeglasses having lenses and temples. For example, as shown in FIG. 11A, rail 1120 may be coupled to the temple, enabling movement of the radar 1130 along the rail 1120. FIG. 11B shows a front view of the person 1110, in which the rail 1120 is located in the frame, enabling the radar 1130 to move horizontally, for example from left to right. In FIG. 11C, the rail 1130 is coupled to a band located in the rear part of the person's head, enabling the radar 1130 to move horizontally, for example from left to right. In FIG. 11D, the rail 1130 is located on a head band. In FIG. 11E, the rail 1130 is located on an external surface of a hat worn by the person.

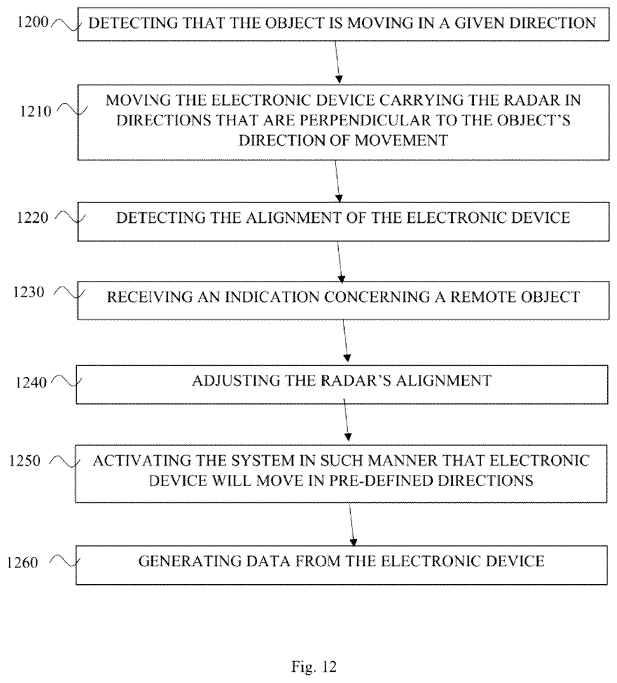

FIG. 12 shows a method for operating a SAR radar, according to exemplary embodiments of the invention. The method is performed on a SAR placed on a stationary object (or integrated in it).

Step 1200 discloses detecting that the object is moving in a given direction. The detection may be performed using a GPS located in the radar, or using a motion sensor such as an accelerometer.

Step 1210 discloses moving the electronic device carrying the radar in directions that are perpendicular to the object's direction of movement. For example, assuming the object flies to the north, moving the device upwards or downwards, or from east to west (right to left headings).

Step 1220 discloses detecting the alignment of the electronic device. The detection may be performed using the tilt sensors, or other sensors, such as the image sensors.

Step 1230 discloses receiving an indication concerning a remote object. The indication may include a relative direction and distance from an object emitting a signal, for example using a direction-finding (DF) technique. the indication of an object of interest may be provided using a camera in the electronic device. Details of the object of interest may be stored in a memory address accessible to the device. The indication may be provided via an input unit in which the user provides operational control commands to the electronic device. The commands may include to cover a relative direction of interest vs the electronic device's heading. The indication may include a level of movement of objects or elements in the device's environment. The level of movement may be extracted from an image captured by the device's camera.

Step 1240 discloses adjusting the radar's alignment. This step is optional and is performed in case there is a need to redirect the radar's antennas at a specific direction. For example, aligning the antennas 10 degrees in the Z axis.

Step 1250 discloses activating the system in such manner that electronic device will move in pre-defined directions. The predefined directions may be activated in response to an event, such as identifying an object or a scene property. The predefined directions may include moving the radar to a predefined location in a rail.

Step 1260 discloses generating data from the electronic device, such as images.

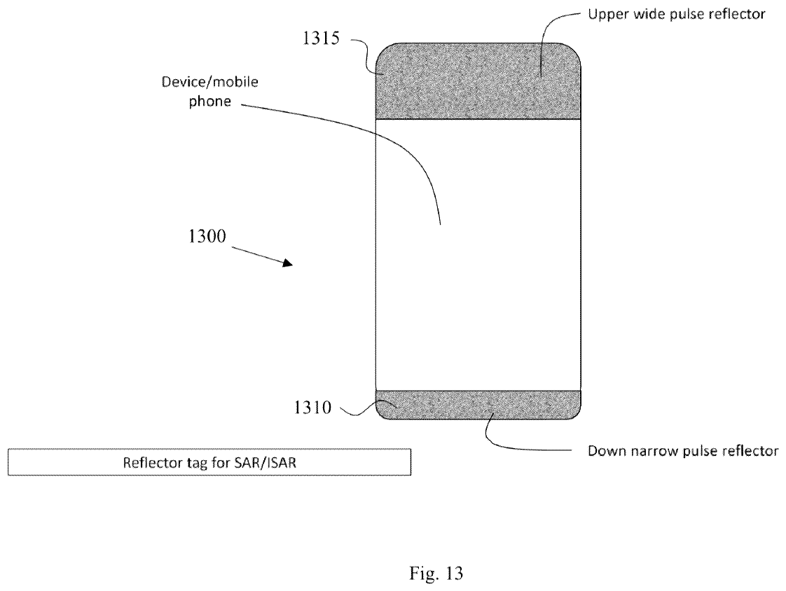

FIG. 13 shows a physical device comprising two tags configured to be identified by a radar, according to exemplary embodiments of the invention. The physical device may be a smartphone 1300, or any other device, such as a vehicle, building, television, person, animal, tree, and the like. The smartphone has two tags placed thereon, a top tag 1315 placed on an upper portion of the smartphone 1300 and a bottom tag 1310 placed on a bottom part of the smartphone. The tags 1310, 1315 differ in at least one property as disclosed above, enabling the radar to distinguish between them based on the reflected signals, hence identifying the upper portion and the bottom portion of the smartphone 1300.

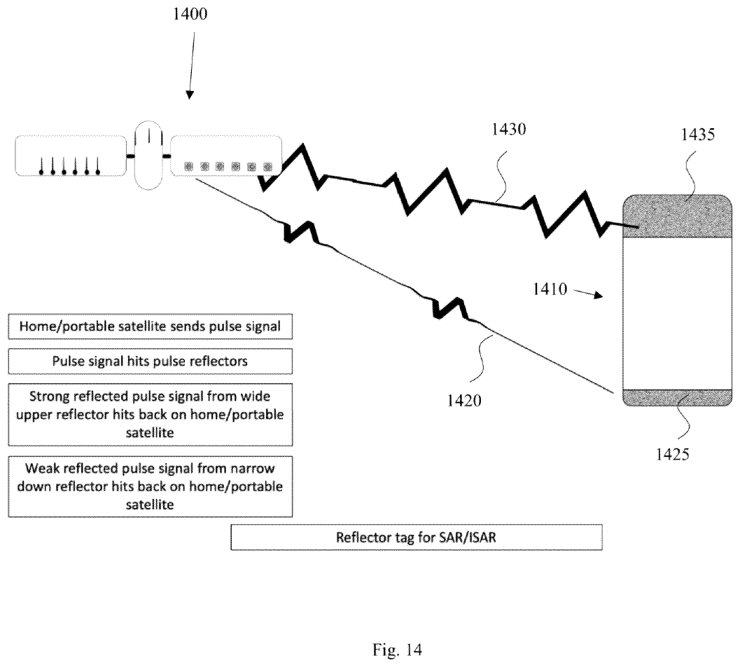

FIG. 14 shows a radar receiving a reflected pulse from a physical device comprising tags, according to exemplary embodiments of the invention. The radar 1400 generates a pulse signal hitting the smartphone 1410 and the tags 1435, 1425. As the tag 1435 is significantly larger than the tag 1425, the signal 1430 as received by the radar 1400 is stronger than the signal 1420 sent as a reflection from the tag 1425. This way, the radar 1400, or a processor coupled to the radar 1400, can distinguish between the tags 1425, 1435, therefore distinguish between the top part and the bottom part of the smartphone 1410.

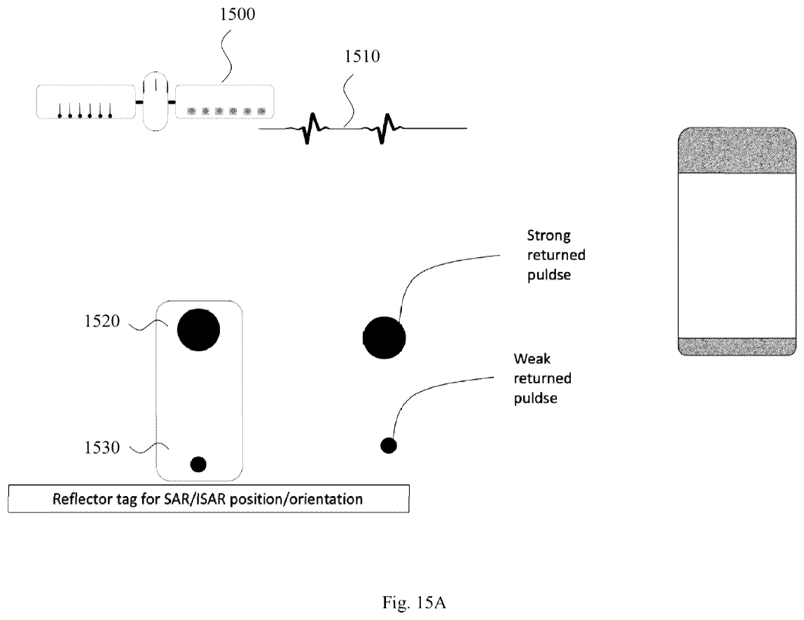

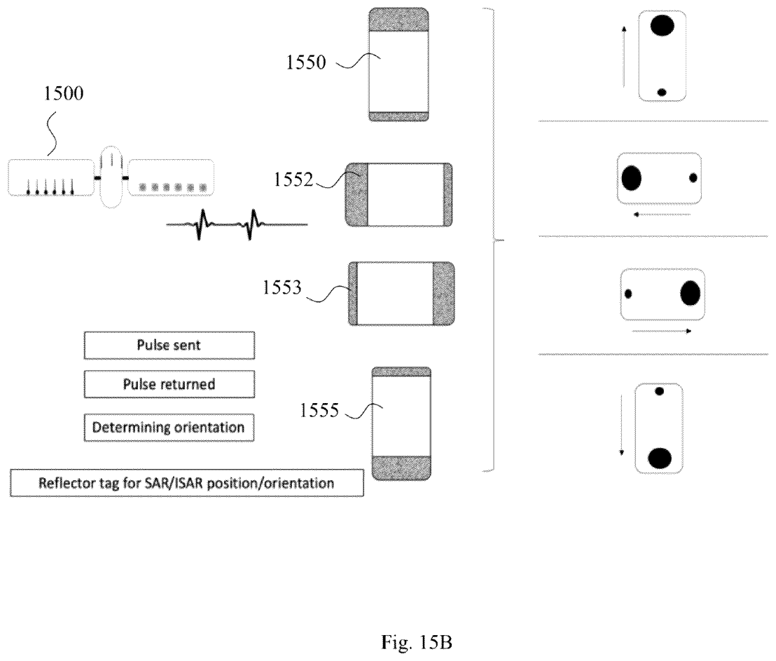

FIGS. 15A-15B show a method for determining an orientation of a physical device using tags placed on the device and a radar, according to exemplary embodiments of the invention. In FIG. 15A, the radar 1500 emits a pulse 1510 reflected from the tags 1520 and 1530. Since tag 1520 is larger than the tag 1530, the processor of the radar 1500 can identify the location of each tag 1520, 1530 on the smartphone. In case one tag is located in each surface of the smartphone, the radar 1500 can identify which surface of the smartphone faces the radar 1500. In FIG. 15B, the radar 1500 identifies several orientations of the smartphone based on the tags 1520, 1530. For example, smartphone 1550 is oriented with the upper part on top, while smartphone 1555 is oriented with the upper part at the bottom, upside down. Similarly, smartphone 1552 is oriented with the upper part on the left side, while smartphone 1553 is oriented with the upper part on the right side.

The subject matter may also disclose a method for operating at least two sperate rail systems with at least 2 electronic devices—one device in each rail. Such method may use a central unit capable to communicate and control said rail system. The central unit may then operate the electronic devices in such manner that they will move in opposite directions, while for example the rails are parallel, thus enabling better coverage of the same scanned area.

The subject matter may also disclose a method for identifying an object, mainly a physical object, in an image created by the signals received by the antennas. In case the physical object comprises a tag or another object capable of influencing or marking the signals received by the antennas, the processor identifies the pattern or other content formed by the tag, and identifies the object based on rules stored in the system's memory. This way, the processor can add an object to the image created based on the signals received by the antennas, even if the object was not detected directly by the antennas, based on the tag.

The tag may have different characteristics in different elements or areas in the tag. The tag may have different characteristics in different sides of the tag. The tag may be configured (either ad-hoc or pre-configured) to represent a specific item and/or a specific area in an item.

In an exemplary embodiment, an object may include multiple different radar tags on its surface. For example, one such tag may be circular while the other is rectangular. The multiple tags may differ in at least one property such as shape, size, material, texture, pattern and the like. In some cases, each tag of the multiple tags may be placed in a different area of the object. For example, one tag is located at the upper front side, while another tag is placed at the lower front side. The tags may be associated with a specific device—i.e., “John's phone”.

The subject matter also discloses a method to use such radar tags, in which the electronic device may scan the object with the radar, identify the tags, and since their configuration is known in the system, can determine the orientation of the object. The tags may also enable the system to determine that the scanned object is a phone, and that its John's phone. The system may be configured to perform a process of adding tags to the system's memory. The radar tags may be placed on rear bumpers of cars, on clothes, on IoT items, or any item selected by a person skilled in the art. The tags' characteristics are stored in the system and are used to identify objects scanned by the radar. The radar tags may be used to help the system determine what is the scanned object when the scanning conditions are not optimal or when the radar lacks the resolution or when the radar is not in the best angle to enable that.

The system comprises electrical circuitry for executing the processes disclosed above and for controlling the system's components. The system comprises a memory for storing information. The memory may store a set of instructions for performing the methods disclosed herein. The memory may also image processing algorithms used to reconstruct images based on the radar's measurements. The memory may also store rules for moving the radar, for example moving along the rail or moving using an arm, based on an event, or based on data extracted from the radar's measurements. The memory may store data inputted by the user, such as commands, preferences, or information to be sent to other devices, and the like.

The system may also comprise an input unit for receiving information or commands from the user of the system. The input unit may comprise a microphone that can be used to receive voice commands from the user. The input unit 920 may enable the user to control the movement of the radar in the system.

The system may also comprise a Direction Finding (DF) unit for finding the relative direction and/or the relative distance of a device or a source of a signal relative to the radar. The DF unit may be RF-Based (radio). The DF unit may be audio/sound-based. The DF unit may be light-based. The DF unit may include at least one antenna used for the DF. The DF unit may be located in different parts or sides of the system. The DF unit may include RF absorbing materials as part of the DF unit. The DF unit may be UWB-based DF techniques and/or methods. The DF unit may apply at least one DF mean or combination of DF means.

The system comprises a processor that manages the operation of the electrical components of the system. The processor may include one or more processors, microprocessors, and any other processing device. The processor is coupled to the memory for executing a set of instructions stored in the memory. The processor may send commands to the actuator that moves the radar in the system.

The system may be configured to a specific user. The system may include means to identify the user—such as, but not limited to, voice print and/or iris detection, and or face detection and the like. The system may use security means to enable at least one specific user to use it. Said security means may use the user's identification means. The system may include means to enable the user to set priorities and/or permissions to other possible users regarding the level of control, access, data, and identification of items within the system.

While the disclosure has been described with reference to exemplary embodiments, it will be understood by those skilled in the art that various changes may be made, and equivalents may be substituted, for elements thereof without departing from the scope of the invention. In addition, many modifications may be made to adapt a particular situation or material to the teachings without departing from the essential scope thereof. Therefore, it is intended that the disclosed subject matter not limit the invention to any particular embodiment thereof.

What is claimed is:

1. A system, comprising:
a device having a body;
at least one Synthetic-aperture radar (SAR) coupled to the body;
at least one rail coupled to the body; and
an actuator for moving the SAR along the at least one rail.

2. The system of claim 1, further comprising at least one antenna allocated to each SAR of the at least one SAR.

3. The system of claim 1, wherein the device comprises multiple antennas and multiple SARs and a switching circuitry for switching the antennas allocated to a selected SAR of the multiple SARs.

4. The system of claim 1, further comprising a tilting mechanism for tilting the antenna alignment in the SAR such that a sector scanned by the radar changes relative to the body.

5. The system of claim 1, further comprising multiple rails spanning the body, at least two rails of the multiple rails intersect with each other, wherein the actuator moves the SAR from a first rail of the multiple rails to a second rail of the multiple rails.

6. The system of claim 1, wherein the at least one rail is foldable.

7. The system of claim 1, further comprising an alignment actuator for changing an alignment of the at least one rail thereby changes the alignment of the device.

8. The system of claim 1, further comprising a rail actuator for moving the at least one rail relative to the body.

9. The system of claim 1, further comprising at least one image sensor.

10. The system of claim 9, further comprising an image sensor actuator for aligning the image sensor to the direction of the SAR device.

11. The system of claim 1, further comprising direction-finding means.

12. The system of claim 1, further comprising a memory device for storing information defining objects, wherein the SAR is configured to detect the objects, wherein the SAR moves in response to movement of the objects.

13. A method of operating a system having a Synthetic-aperture radar (SAR), the method comprising:
receiving a command to use the SAR, the command comprising an azimuth;
moving the SAR along a rail in a body of the system, without changing an azimuth of a body of the system; and
sending a confirmation message indicating that the SAR is in position based on the command.

14. The method of claim 13, further comprising changing an alignment of the rail based on the azimuth.

15. The method of claim 13, further comprising tilting the antenna alignment in the SAR such that a sector scanned by the radar changes relative to the body.

16. The method of claim 13, further comprising folding the rail inside the system.

17. The method of claim 13, wherein the system comprising multiple rails spanning in the body, at least two rails of the multiple rails intersect with each other;
wherein the method further comprising moving the SAR from a first rail of the multiple rails to a second rail of the multiple rails.

18. The method of claim 13, further comprising identifying movement of the system's body and moving the SAR on a rail having a direction perpendicular to the body's movement.

19. The method of claim 13, further comprising detecting an alignment of the system's body and changing an alignment of the rail according to the detected alignment.

20. The method of claim 13, further comprising identifying a relative direction of a source of a signal using a direction-finding (DF) unit and adjusting an alignment of the SAR to be directed at the identified relative direction of the source.

21. The method of claim 13, further comprising identifying an object using a camera and adjusting an alignment of the SAR to be directed at the identified relative direction of the source.

22. The method of claim 13, further comprising receiving a command from a user operating the system and adjusting the alignment of the SAR to be directed according to the command.

23. The method of claim 13, further comprising receiving a signal by the antennas and identifying a physical object based on the properties of a tag placed on the physical object by comparing the tag's properties to tags' properties.

24. The method of claim 13, further comprising identifying a section of the physical object, wherein the physical object is coupled to multiple tags, each tag of the multiple tags is associated with the section of the physical object, such that identifying a specific tag of the multiple tags results in identifying the section of the physical object.
